(19) United States
(12) Patent Application Publication
(10) Pub. No.: US 2005/0161413 A1
(43) Pub. Date: Jul. 28, 2005

(54) Method and apparatus for in-carton display and fronting of merchandise items

(76) Inventor: James Garth Close, Georgetown, TX (US)

Correspondence Address: Rick B. Yeager, 10805 Mellow Lane, Austin, TX, 78759, US

(21) Appl. No.: 11/000,596

(22) Filed: Dec. 1, 2004

Related U.S. Application Data
(60) Provisional application No. 60/526,285, filed on Dec. 3, 2003.
(60) Provisional application No. 60/530,357, filed on Dec. 18, 2003.

(51) Int. Cl. B42F 1/00

(52) U.S. Cl. 211/51

(57) ABSTRACT

An elastic alignment mechanism utilizes cloth elastic strips to pull a rear engagement element toward the front of a display carton. As items are removed from the carton, remaining items are pulled forward. In one embodiment, the items may rest on the bottom of the carton, and the products are pulled by a rear engagement member, such as plastic or cardboard, which is pulled by elastic strips which are secured to the front of the carton. In one embodiment, the mechanism includes a reusable support base, and the elastic strip is provided below the row of items. The strip may be wound around one or more sheaves to decrease the required working range of the elastic. In one embodiment, cardboard support ribs are built into the bottom of the carton, so that the elastic strip may be provided below the items which are supported on the ribs.

### RELATED APPLICATIONS

This application is related to Provisional Application #60/526,285 filed Dec. 1, 2003 for Auto feed display carton and Provisional Application #60/530,357 filed Dec. 10, 2003 for Zzip elastic display system, and claims priority form those provisional applications.

### BACKGROUND OF INVENTION

The invention relates to the in-carton display of products such as those packaged in bottles, jars, cans, pouches, envelopes, and boxes, and more particularly to devices and methods in which products displayed in a carton can easily be moved forward for improved visual exposure and effortless selection by consumers.

### BACKGROUND OF INVENTION

Retail stores relying on the consumers to serve themselves have recognized the importance of displaying products near the front edge of display cartons so that the products can be readily seen by consumers and easily reached by the customers. Customers typically remove products from the front of a carton, and products remaining toward the rear of the carton may be difficult to see or to reach. This problem is aggravated by the increasing use of in-carton displays where sales may be lost if products are not visible from the front of the carton. In order to compensate for the difficulty in seeing products at the rear of a display carton or seeing those products that have fallen over to the bottom of a carton, manufactures have adopted the use of relatively short cartons, where each carton may be only a fraction of the shelf depth.

As more products are merchandised directly from cartons, there is a need for product alignment devices which provide automatic alignment of items in a display carton. It is desirable to provide effective display in a single long carton, rather than several shorter cartons. The longer cartons reduce packaging costs and retail labor.

Suppliers are using small shipper boxes to try to keep pouched product from falling into the box and disappearing from the customer's eye. The small boxes are an inefficient solution, because they require repetitive printing, and they are often lost on the shelf behind other boxes creating poor sales and inventory problems. The small boxes can not keep the product well fronted past the first few pouches.

Grocery and discount stores are cutting costs by requiring suppliers to display their products in the same shipper boxes in which the product arrived at the store, and it is desirable to provide a solution that permits effective shipment and display.

### SUMMARY OF THE INVENTION

The current invention relates to a device, system and method for displaying and automatically re-aligning products in a display carton. The current invention includes various embodiments of the ZZIP™ system for in-box merchandising and fronting. The system and methods typically use elastic or spring mechanisms to drive pull members to automatically front items in a display carton. In some embodiments, the alignment mechanism is separate from the carton. In other embodiments, a portion of the device is secured to the carton.

In one embodiment of the current invention, a carton of multiple merchandise item containers, such as product pouches, is automatically aligned with an elastic alignment mechanism which provides a pressure to pull or push remaining item containers forward in the display carton as items are removed by customers. In one embodiment, the alignment device includes one or more elastic strips which act on a rear pull member to provide a pressure from the rear of the row of item containers.

In various embodiments, one or more elastic strip may be secured to a portion of the carton such as by glue or staple, such as stapling the strip to the front, back, side, or bottom of the carton. In other embodiments one or more elastic strip may be anchored directly into slots on the front of the display carton, such as by knotting or otherwise enlarging the strip ends, or by securing a portion of the elastic strip in a retention slot on the carton. In other embodiments one or more elastic strip may be secured by attaching the strip ends to a front retention element which is held in proximity to the front of the carton; or by attaching the elastic strip.

The elastic strip or strips pull the rear pull member toward the front of the carton. The rear pull member may include side extensions, such as side flaps, to confine the item containers. When the side extensions advance to the front of the carton, the side extensions maintain a gap between the front of the carton and the rear pull member.

The elastic strip or strips may be provided in an excess length, such as in the rear of the rear pull member so that the working elastic range of the elastic strip is effective over the path of the item containers to be moved forward. For instance if the display carton is 20 inches long, the total amount of elastic provided in the system may be 30 to 40 inches, so that the overall stretch required is relatively low. One way to express this stretch is the ratio of stretched length to unstretched length. Although greater ratios can be used, many of the embodiments described below attain a ratio in the range of 1.5 to 4.0. By contrast, if one or more elastic strips were simply attached to the closest point on a rear pull member, the ratio of stretched length to unstretched length of the elastic strip would be substantially higher as illustrated in examples below. By maintaining a relatively low required stretching, the stretching may be repeated indefinitely so that the elastic device may be re-used indefinitely. Another advantage of reducing this stretch ratio is to provide a more uniform force on the rear pull member throughout the working range of the device.

In another embodiment, the elastic alignment mechanism may be a disposable alignment device. The device may be provided in the carton. For instance, envelope packaged products such as soup mix, or light box products such as gelatin, are typically provided in store-ready display cartons. In one embodiment, these cartons include a rear pull member which has an elastic strip attached to each side. Upon opening the carton for display, the rear pull member may be placed behind the merchandise items, and each strip is stretched toward the front of the carton. The elastic strips may be retained at the front of the carton, such as with slots on the carton to accept the strips, and by a retaining bar holding the strips in place relative to the front of the carton. In one example, the elastic alignment mechanism is made of low cost elastic strips and a low-cost cardboard rear pull member.

In another embodiment of the current invention, an elastic alignment mechanism is provided for insertion into a carton of merchandise item containers. The device may be inserted at the factory or may be inserted at a retailing site such as a grocery store.

In one embodiment, the elastic alignment mechanism may comprise a reusable display base with an elastic drive mechanism. The elastic alignment mechanism may be placed in the bottom of a display carton, so that the carton has full height or partial height side walls, so that the walls of the display carton retain merchandise items from lateral movement, and so that the elastic alignment mechanism re-aligns items toward the front of the display as some items are removed.

In one embodiment, a carton such as a cardboard box is typically inverted, the side walls are cut so that the bottom of the box and a lower portion of the side walls can be removed, the elastic alignment mechanism is inserted in the bottom portion of the carton or directly over the merchandise items, the bottom portion of the carton is re-positioned over the items, the display carton is re-inverted so that the merchandise items rest on the display base, and the top portion of the display carton is removed. In this embodiment, the reusable display base aligns items within a portion of the original carton. The device may include a locking means which keeps the device in an extended position until time to place the carton in service.

In another embodiment, the elastic alignment mechanism may be inserted underneath items by cutting a hole in the side of the carton, and inserting the unit. In some embodiments, the alignment mechanism may comprise a spring driving means, rather than an elastic strip driving means.

A relatively smooth elastic strip material may be used to drive the alignment mechanism to pull products toward the front of a display carton. The elastic strip material may be routed over rollers, pins, pulleys, or sheaves so that its extended length is approximately 2-3 times the display depth, and so that its expanded length is approximately two to four times its contracted length. The elastic strip material has good properties including low cost, relatively high strength, durability, and retained working strength. In other embodiments, other materials and other working ranges of the elastic driver may be used.

In another embodiment, items in containers such as cans, bottles, and boxes are shipped so that the containers rest on a disposable elastic alignment mechanism which is part of the package. In this embodiment, a support means such as cardboard rails are provided with the carton so that the rails hold the items in an elevated position relative to the carton bottom. An elastic pull means is provided so that an elastic strip may be positioned in the space between the rails-below the product items and above the carton bottom. The elastic pull means may be a unit which is inserted from the side wall of the carton. The elastic pull means typically is one or more elastic cloth strip. In one embodiment, the strip may be wound around rollers or pins in order to accommodate a relatively long elastic strip in order to reduce the required elastic working range of the elastic strip.

### DESCRIPTION OF FIGURES

FIG. 1A is a perspective view of an elastic alignment mechanism.

FIG. 1B is a perspective view of the elastic alignment mechanism of FIG. 1A in a display carton.

FIG. 1C is a perspective view of the elastic alignment mechanism folded and placed in a carton of merchandise items.

FIG. 2A is a top view of a first example which illustrates the stretched and unstretched length of an elastic strip.

FIG. 2B is a top view of a second example which illustrates the stretched and unstretched length of elastic strips.

FIG. 2C is a top view of a third example which illustrates the stretched and unstretched length of elastic strips.

FIG. 2D is a top view of a fourth example which illustrates the stretched and unstretched length of elastic strips.

FIG. 3A is a perspective view of an elastic alignment mechanism with a base.

FIG. 3B is a detailed side view of a lock and access hole for the device of FIG. 3A.

FIG. 3C is a perspective view of the device of FIG. 3A with the rear pull member removed.

FIG. 3D is a perspective view of the device of FIG. 3C with the elastic strip removed.

FIG. 4A is a side view of an elastic alignment mechanism placed upside down on top of the merchandise items in an inverted carton.

FIG. 4B is a side view of an inverted with the bottom cover flaps closed.

FIG. 4C is a side view of the carton of FIG. 4B in an upright position.

FIG. 4D illustrates the elastic alignment mechanism aligning products in the carton of FIG. 4D.

FIG. 5A is a perspective view of an alternate elastic alignment base.

FIG. 5B is a perspective view of a rear pull member for the base of FIG. 5A.

FIG. 5C is a side view of the elastic alignment base of FIG. 5A with the rear pull member of FIG. 5B.

FIG. 5D is a perspective view of the elastic alignment base of FIG. 5A with the rear pull member of FIG. 5B.

FIG. 6A is a side view of the elastic alignment mechanism in a locked position on top of merchandise items in an inverted carton.

FIG. 6B is a side view illustrating the unlocking of the elastic alignment mechanism of FIG. 6A.

FIG. 6B is a side view illustrating the locked position of the elastic alignment mechanism of FIG. 6A.

FIG. 7A is a front view cross section view of a carton with integral merchandise support ridge features.

FIG. 7B is a side view of the carton of FIG. 7A.

FIG. 8A is a perspective view of an elastic alignment mechanism.

FIG. 8B is a top view of an elastic alignment mechanism of FIG. 8A.

FIG. 9 is a cross section view of a rear pull member.

FIG. 10A is a front view of a product container supported on support ridges.

FIG. 10B is a bottom view of the container of FIG. 10A.

FIG. 11 is a perspective view of an opened display carton, merchandise items, and an elastic alignment mechanism.

FIG. 12A is a side view of an example elastic alignment mechanism with a base.

FIG. 12B is a side view of another example elastic alignment mechanism with a base

FIG. 12C is a side view of another example elastic alignment mechanism with a base.

FIG. 13 is a front perspective view of a multiple carton display where each carton has an elastic alignment device.

FIG. 14A is a bottom perspective view of a multiple elastic alignment devices placed in a carton.

FIG. 14B is a bottom perspective view illustrating unlocking elastic alignment devices of FIG. 14A.

FIG. 14C is a top perspective view of a display carton of FIG. 14A.

FIG. 15A is a top perspective view of an elastic alignment device.

FIG. 15B is a top perspective view of a rear pull member for the elastic alignment device of FIG. 15A.

### DETAILED DESCRIPTION OF EMBODIMENT

### Elastic Alignment Mechanism

In one embodiment of the current invention, multiple merchandise item containers, such as product pouches, are shipped to a retailer in a carton. The carton is intended to be used for merchandise display, so that the retailer is not required to remove the merchandise items from the carton, such as to place the merchandise items on a display shelf. The retailer inserts an elastic alignment mechanism into the carton, so that the elastic alignment mechanism provides a pressure to pull remaining merchandise items forward in the display carton as merchandise items are removed from the carton by customers.

In this example, the elastic alignment mechanism includes elastic strips which are secured to the front of the carton and to a rear card which serves as a rear pull member. The elastic strips are stretched so that the rear card is pulled toward the front of the carton as items are removed from the carton.

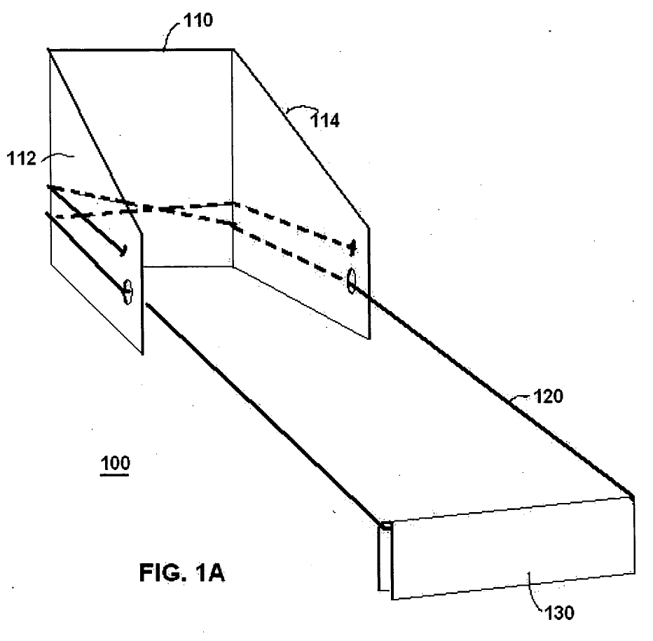

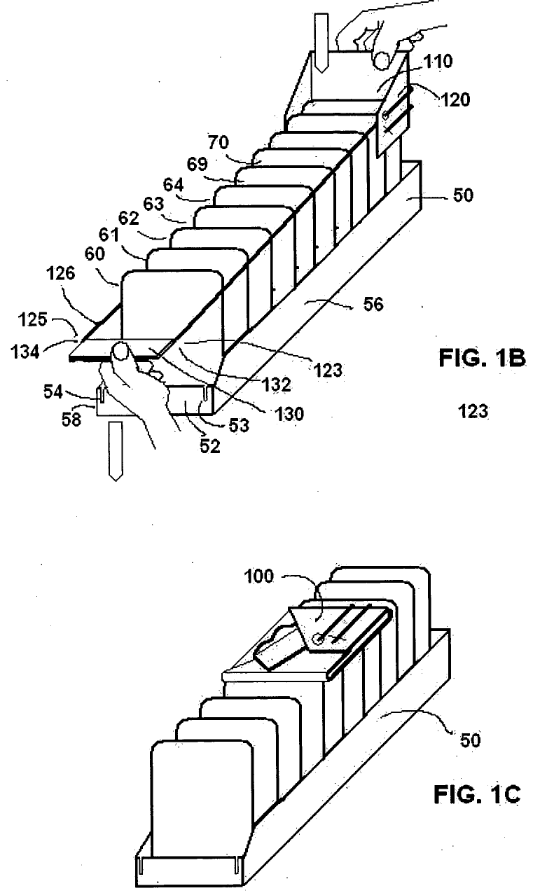

FIG. 1A is a perspective view of the Zzip™ elastic alignment mechanism 100. The device includes a rear card 110 which serves as a rear pull member for engaging an item in a product container. The rear card is typically made of cardboard or plastic. The rear pull member may include side flaps 112 and 114, which serve as side extensions. These side extensions act to stabilize the rear card, and also act to contain the merchandise items, and to provide a front stop so that in its most forward position, the rear card is held under a slight tension. This front stop provides a gap between the front of the carton and the card so that a customer may replace an item into the carton.

FIG. 1B is a perspective view of the Zzip device 100 in a display carton 50. The carton has a front 52, a first side 56, and a second side 58. The carton holds a row of merchandise items 60-70. The rear card 110 is inserted at the back of the row of items. In this example, an elastic strip 120 is provided, so that a first portion 122 of the strip is positioned along the right side of the merchandise items, and so that a second portion 126 of the strip is positioned along the left side of the merchandise items. In other examples, the strip or strips may be routed below the merchandise items.

The first portion and the second portion may be part of a single elastic strip as shown in FIG. 1B, or they may be separate strips. A front retention element 130, such as a bar, has a first end 132 and a second end 134. The first end 123 of the elastic strip is secured to the first end 132 of the bar. The second end 125 of the elastic strip is secured to the second end 134 of the bar. The front 52 has a first slot 53 which holds a portion of the elastic strip near the first end 123 of the elastic strip; and a second slot 54 which holds a portion of the elastic strip near the second end 125 of the elastic strip. The slots permit the front retention element to be placed on the outside of the front of the carton so that the elastic strip may be stretched toward to rear card. In this example, the front retention element and the slots in the front of the container provide a means for retaining the elastic strip or strips. Other strip retention means may be used.

In this manner the elastic strip acts on the rear card to pull remaining items forward as items are removed from the display carton. This application permits the use of a longer carton than what might typically be used in a grocery application. One reason that relatively short cartons are used in many applications is to prevent a situation where items removed were out of view of a potential customer. By pulling items forward packaging cost maybe reduced by permitting units to carton which corresponds to the shelf depth.

In another embodiment, two or more strips of elastic are used, such as a first strip on the right side and a second strip on the left side of the merchandise items.

Referring now to FIG. 1C the Zzip device 100 may be folded and included in cartons of merchandise so that a stocker can place the Zzip device in the cartons at the same time that the cartons are prepared for display. The elastic alignment mechanism may be removed, unfolded and inserted into the carton in order to pull the item forward as described above. The side flaps may extend beyond the thickness of an item in order to stop the pusher element a desired distance from the front of the carton.

In other embodiments, the elastic alignment mechanism device may be positioned in the carton at the time that the carton is shipped, so that the device is active at the time that the carton is opened for display. In this case of pre-packaging the elastic alignment mechanism, the elastic strip or strips may be directly secured to the front of the inside front of the carton such as by adhesively or mechanically attaching the strip ends directly to the carton front; or by adhesively or mechanically attaching a plate to the carton where the plate is affixed to the elastic strip or strips. Staples or clamps are examples of mechanical attachment. Another example of mechanical attachment is placing the end of the elastic strip through a slot in the carton and knotting or otherwise enlarging the end of the elastic strip to prevent the strip from being pulled through the slot.

In one embodiment, the elastic strip or strips are provided in length such that when the rear pull member is in its most forward position, there is only a slight tension on the strip. This slight tension is sufficient to hold the rear pull member in a forward position.

### EXAMPLE 1

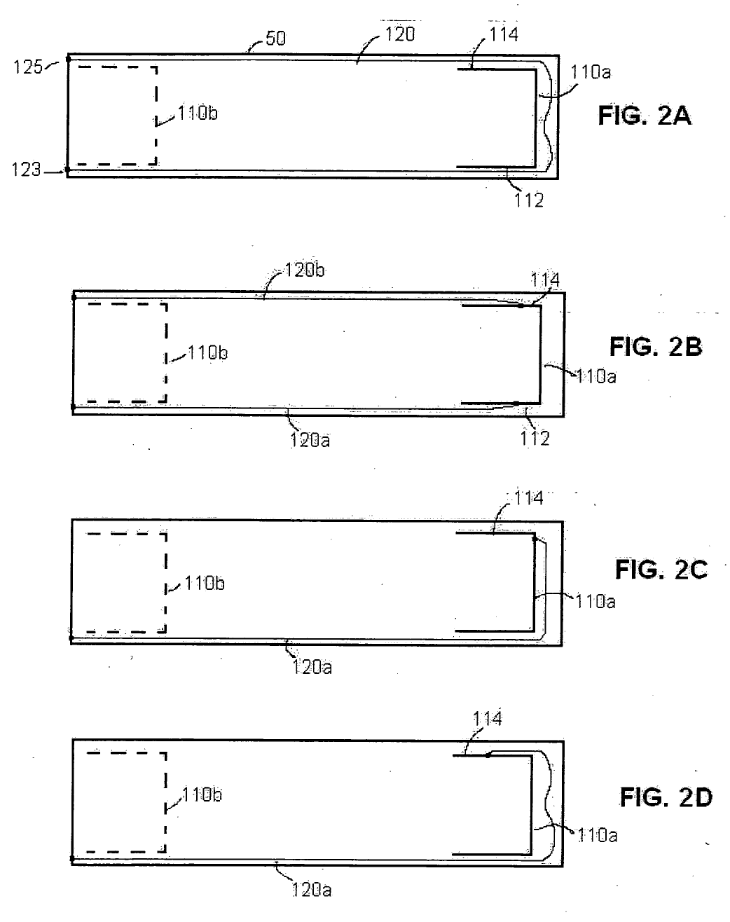

Referring now to FIG. 2A, in this example, the carton has a length of 20 inches, a single elastic strip is used in a manner that provides a single, essentially planar, path around the rear pull member. In this example, the elastic strip is mechanically attached, such as stapled, or adhesively attached to the rear pull member. The side flaps have a length of 4 inches and the rear pull member has a width of 5 inches. In this example, the elastic has an unstretched length of about 13 inches—4 inches for each side and 5 inches for the rear pull member when the pull member is in its forward position 110b. The elastic strip has a stretched length of about 45 inches—20 inches for each side and 5 inches for the rear pull member in its rear position 110a. In this example, the ratio of stretched to unstretched length is about 45/13 or about 3.5.

### EXAMPLE 2

Referring now to FIG. 2B, if the elastic of Example 1 is two strips 120a and 120b which are attached to the midpoint of the side flaps, then each strip has an unstretched length of about 2 inches and a stretched length of about 18 inches. In this example, the ratio of stretched to unstretched length is about 18/2 or about 9.0. This high ratio requires an elastic material with a very good stretch properties—particularly if it is desired to reuse the elastic strip. It is often desirable to lower this ratio as described in the examples below.

### EXAMPLE 3

Referring now to FIG. 2C, if the elastic of Example 1 is provided in two strips, and each strip is secured to, or routed around, the rear pull member in a manner that provides and excess length of elastic material, then the stretched to unstretched ratio may be lowered. For instance, if one end of the right strip 120a is mounted on the left side of the rear pull member, then the elastic has an unstretched length of about 9 inches—4 inches for the right side and 5 inches for the rear pull member. The right strip has a stretched length of about 25 inches—20 inches for the right side and 5 inches for the rear pull member. In this example, the ratio of stretched to unstretched length is about 25/9 or about 2.8.

### EXAMPLE 4

Referring now to FIG. 2D, in this example, the elastic strip of Example 3 is lengthened by about 2 inches such as by either attaching the right strip on the upper left portion of the rear pull, or by attaching the right strip 120a on the left side flap 114. The elastic has an unstretched length of about 11 inches—4 inches for the right side and 7 inches for the rear pull member. The right strip has a stretched length of about 27 inches—20 inches for the right side and 7 inches for the rear pull member. In this example, the ratio of stretched to unstretched length is about 27/11 or about 2.45. By maintaining a relatively low required stretching, the stretching may be repeated indefinitely so that the elastic device may be re-used indefinitely.

### DETAILED DESCRIPTION OF EMBODIMENT

### Elastic Alignment Mechanism with Base

In one embodiment of the current invention, an elastic alignment mechanism is provided for insertion into a carton of merchandise item containers. The device may be inserted at the factory or may be inserted at a retailing site such as a grocery store. This elastic alignment mechanism may comprise a reusable display base and an elastic drive mechanism. The mechanism may be placed in the bottom of a display carton, so that the carton has full height or partial height side walls, so that the walls of the display carton retain merchandise items from lateral movement, and so that the elastic alignment mechanism re-aligns items toward the front of the display as some items are removed.

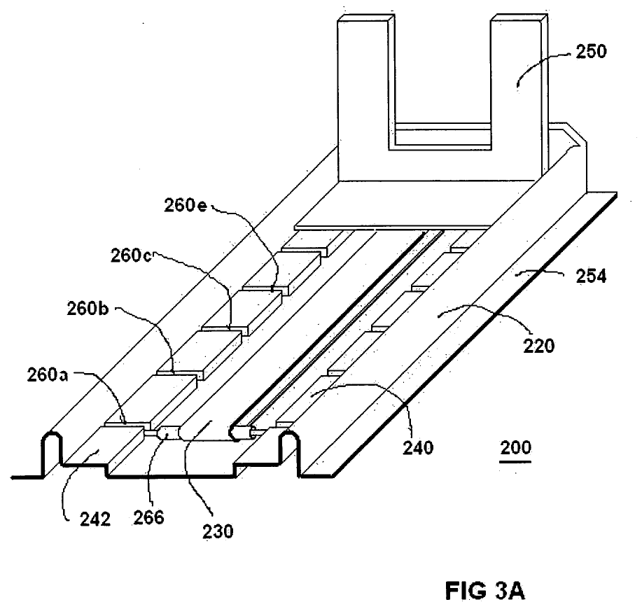

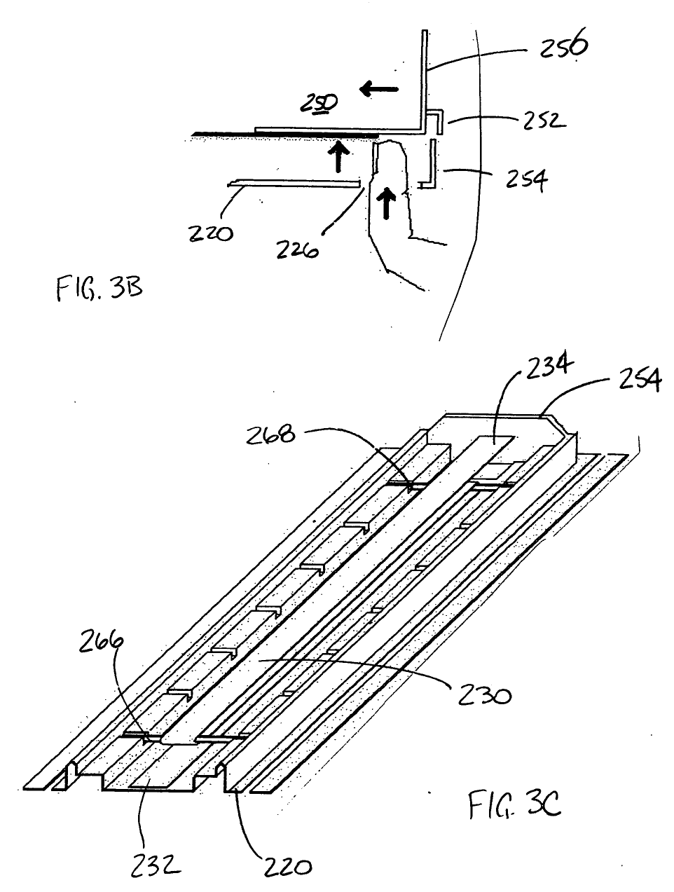

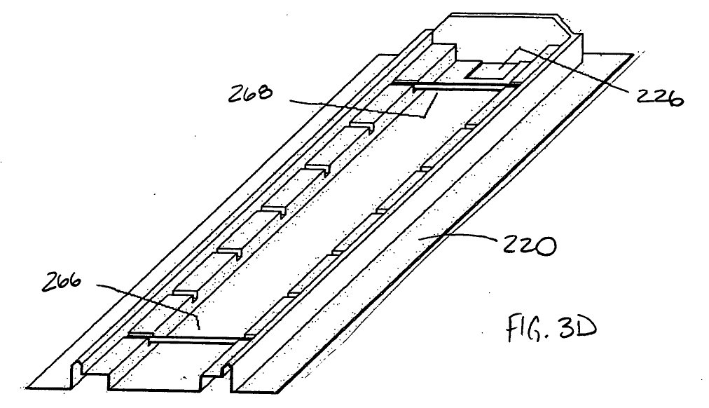

FIG. 3A is a perspective view of a Zzip stick™ elastic alignment mechanism 200. The device includes a base 220 which supports an elastic strip 230 which is wound around a first sheave 266 and a second sheave 268 (not shown) in order to stretch the elastic strip to a rear pull member 250. In other embodiments, the elastic strip may be more directly secured to the rear pull member, without winding the strip around one or more sheaves.

FIG. 3B is a side view of a lock and access hole for the device of FIG. 3A. A finger or other object may be inserted into the access hole 226 to disengage the lock notch 252 from the rear lock 224. In this example, one end of the elastic strip is secured to the base 220, and the second end is secured to the rear pull member 250. The rear pull member 250 includes a rear plate 256 for engaging the products and may include a lock notch 252 for securing the unit in a locked position during transit or until the unit is ready for use. The lock notch 252 fits over a rear lock 224 which may be accessed through an access hole 226 in the base 220 to disengage the rear plate from the pusher base. In other examples, the base may be provided without a locking mechanism.

The base 220 may further include product support ridges 240 and 242 for supporting products at an elevation above the elastic strip so that the strip can pull the rear plate member. These product support ridges act to reduce the contact area of the merchandise items, and therefore reduce the sliding friction. The support ridges also provide a space for routing the elastic strip or strips as described below. The base unit is adjustable in that the first and second sheave 266 and 268 may be placed in any of a plurality of sheave slots 260a-260e. The tension on the elastic strip or strips may be adjusted or selected based on the position of the sheaves. In other embodiments, the items may be supported by a flat base, rather than by product support ridges.

FIG. 3C which is a perspective view of the device of FIG. 3A with the rear pull member removed. FIG. 3D is a perspective view of the device of FIG. 3C with the elastic strip removed. The elastic strip 230 can be shown as secured on the base 220 on the first end 232 of the elastic strip, and wound around the first sheave 266 and the second sheave 268. A second end 234 of the elastic strip may be attached to the rear pull member.

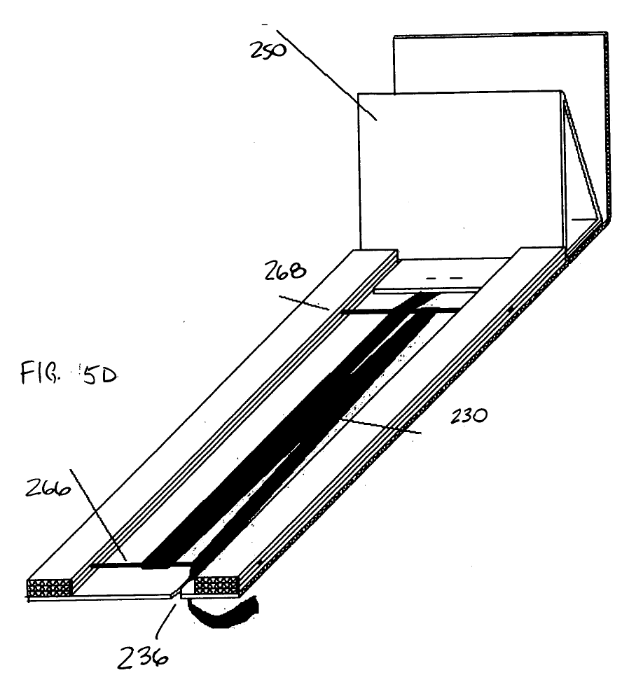

FIG. 5A is a perspective view of an alternate elastic alignment base. In this example, the base 220 may be made of a cardboard material. FIG. 5B is a perspective view of a rear pull member 250 for the base of FIG. 5A showing a lower plate 254 and a rear plate 256. FIG. 5C is a side view of the elastic alignment base of FIG. 5A with the rear pull member of FIG. 5B. FIG. 5D is a perspective view of the elastic alignment base of FIG. 5A with the rear pull member of FIG. 5B. This view shows the use of metal rods 266 and 268 to act as sheaves for the elastic strip 230. The elastic strip is secured near its first end in a retention slot 236.

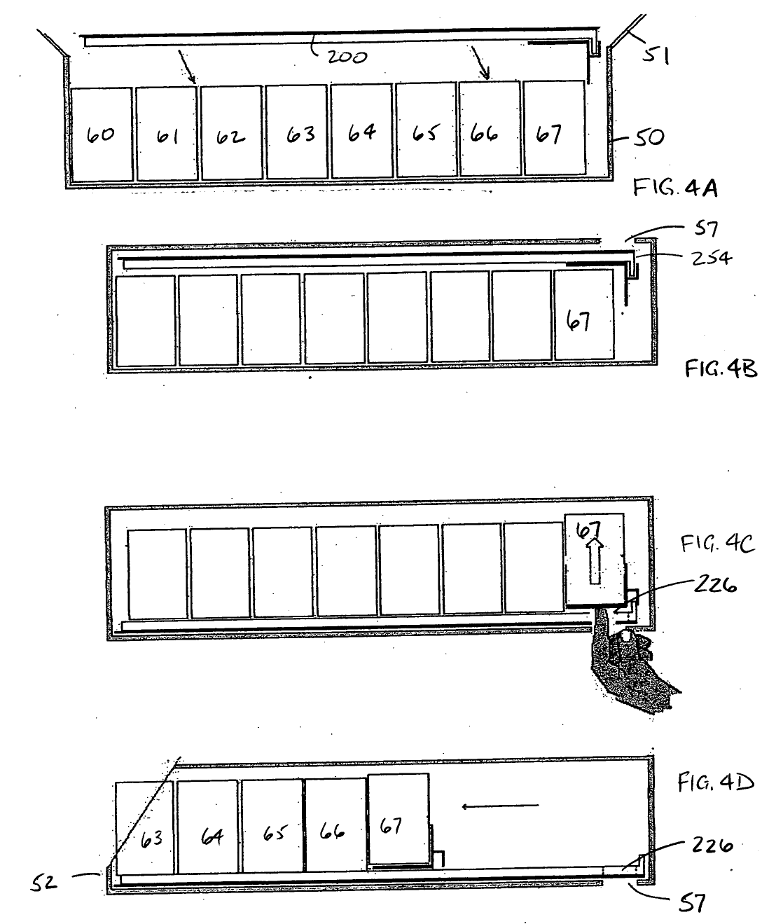

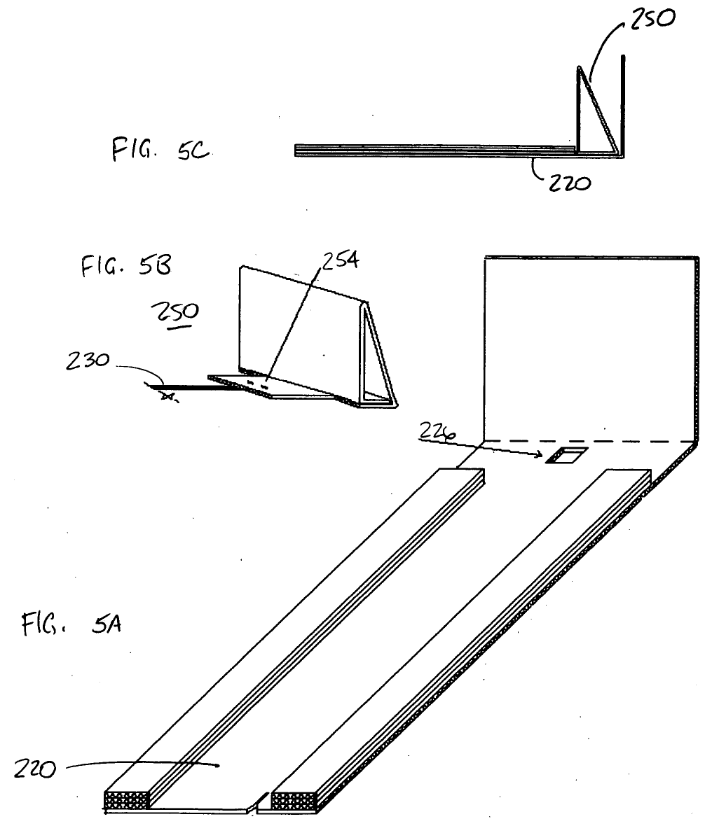

FIGS. 4A through 4D illustrate an example use of the Zzip stick. In FIG. 4A, the carton is turned upside down, and the bottom cover flaps 51 are opened. In an alternate method, the bottom portion of the carton may be cut and removed from the top portion, so that a portion of the side walls are left attached to the bottom of the carton, so that when the carton is re-inverted, the partial side walls retain the merchandise items. The elastic alignment mechanism is placed upside down on top of the merchandise items in the carton, so that the device is in the locked position. The bottom flaps 51 of the carton are closed, as indicated in FIG. 4B, and the carton 50 is inverted back to a right side up position shown in FIG. 4C. A pin or finger is inserted through the access hole 226 in order to unlock the rear pull member 250 so that the rear pull member can move forward. FIG. 4D illustrates the pusher device pushing products forward toward a partially removed front 52 of the carton 50. In this example, items 60, 61, and 62 have been removed and items 63-67 have been pushed forward to the exposed front opening 52 of the carton.

In this example, the rear pull member may be formed as an extruded unit and cut to a desired width or may be formed individually.

### DETAILED DESCRIPTION OF EMBODIMENT

### Carton with Prepackaged Elastic Alignment Mechanism Display Base

In this embodiment, an elastic alignment mechanism, such as described above, is inserted into the bottom of a merchandise item carton, such as a cardboard box, before the carton is shipped. Referring to FIG. 4B, is a side view of an embodiment of the invention, a plurality of merchandise items 60-68 are packed in a carton 50. The carton and the merchandise items are typically upside down. Before the bottom flaps 51 of the carton 50 are sealed, a display base 220 is placed in the carton so that it fits over at least one row of merchandise items.

In one embodiment, the display base includes a rear pull member 250 that is locked in an extended position over a portion of the display base 220. In other embodiments, the merchandise items hold the rear pull member in an extended position. The bottom of the carton is then typically sealed, and the carton may be shipped in an upright orientation. For display, such as in a grocery store, the carton is typically cut open between the bottom and the top of the carton so that the remaining carton sides tend to confine the merchandise items within one or more rows. This display is then typically placed on a display shelf or other support, such as other merchandise cartons. As a merchandise item is removed, the remaining items are forced on the display base toward the front of the display by the rear pull member.

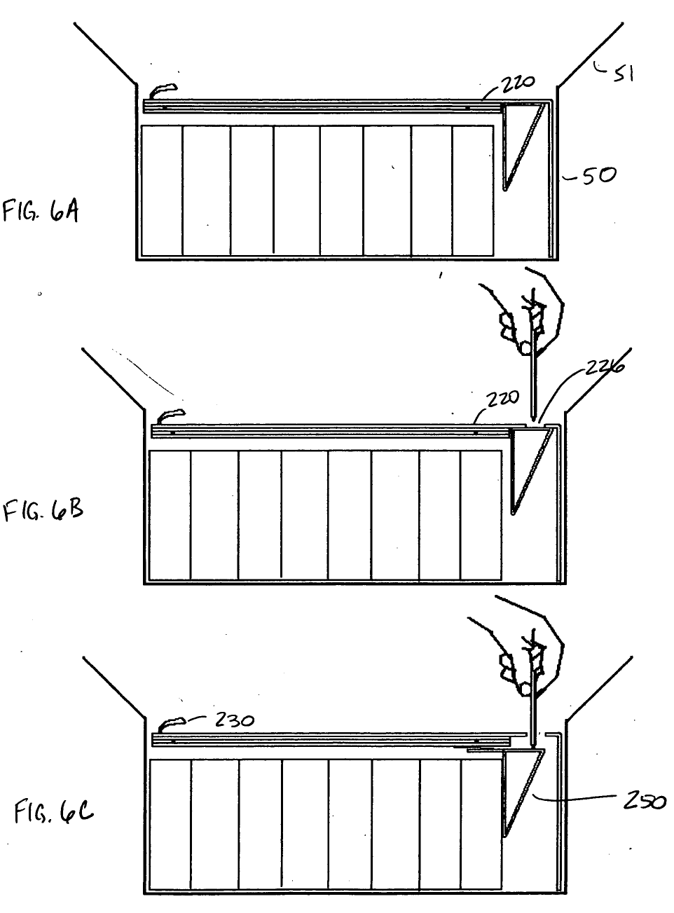

In those cases, where the rear pull member has been locked over the display base, the rear pull member may be released, such as illustrated in FIG. 6A-6C where the rear pull member is accessed through a hole 226 on the display base.

In some embodiments, an elastic alignment mechanism may be used for two or more product rows, so that the mechanism is pulled forward when an item is removed from the longest row served by the device.

### DETAILED DESCRIPTION OF EMBODIMENT

### Elastic Material

In one embodiment, a relatively smooth elastic strip material may be used to drive the alignment mechanism to pull products toward the front of a display carton. One example of a suitable material is the elastic sold for use in garments. This type of material typically has good elasticity and a relatively low friction surface.

The elastic strip material may be routed over rollers, pins, pulleys, or sheaves so that its extended length is approximately 2-3 times the display depth. The elastic strip material preferably has good properties including low cost, relatively high strength, durability, and retained working strength. In other embodiments, other materials and other working ranges of the elastic driver may be used.

In one embodiment, the elastic strips are wrapped around at least a portions of the rear pull member and the side extensions, such as described in the examples above. By providing this extra elastic strip, the ratio of stretched to unstretched elastic strip length is reduced.

### DETAILED DESCRIPTION OF EMBODIMENT

### Selecting and Adjusting Pull Strength

In this embodiment, various combinations of elastic strips may be used to obtain a desired pull force. For instance, a single elastic strip may be used; two elastic strips of equal size may be used, a single band may be used to provide the two strips; or two or more elastic strips of different sizes may be combined.

Additional adjustment may be obtained by the amount of initial stretch provided in the full merchandise position by selecting a desired total path length selected, such as by selecting sheave locations.

### DETAILED DESCRIPTION OF EMBODIMENT

### Spring Alignment Mechanism with Base

In this example, a base and pull member are provided as described above, but a spring mechanism is provided rather than an elastic strip. The spring may be secured in proximity to the front of the base, and stretch a position in the rear of the rear pull member. As the pull member is pulled toward the front of the carton, the spring may form a coil behind the pull member.

### DETAILED DESCRIPTION OF EMBODIMENT

### Integral Carton Base Supports

In this embodiment, merchandise items in containers such as cans, bottles, and boxes are shipped so that the merchandise items are elevated by rail or rib features which are provided on the inside bottom surface of a carton.

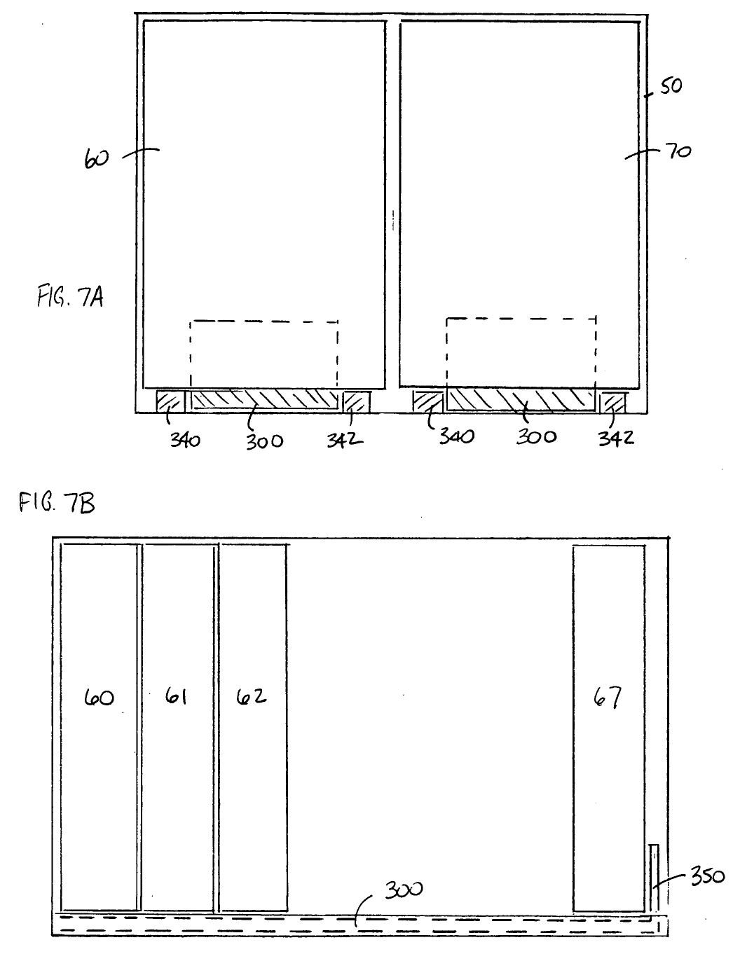

FIG. 7A is a front view cross section view of a carton with integral merchandise support ridge features. FIG. 7B is a side view of the carton of FIG. 7A A row of merchandise items cartons maybe provided with support ridges 340 and 342 integral to the carton 50 so that an elastic alignment mechanism can be installed easily under the elevated items in the carton. In this embodiment, the support ridges, such as cardboard rails, are provided with the carton so that the rails hold the items in an elevated position relative to the carton bottom. An elastic alignment mechanism 300 which includes an elastic pull means 320 is provided so that an elastic strip may be positioned in the space between the rails—below the product items and above the carton bottom. The elastic pull means typically is an elastic cloth strip. In one embodiment, the strip may be wound around sheaves, rollers or pins in order to accommodate a relatively long elastic strip to reduce the required elastic working range of the slip. The unit may be inserted from the side of the carton so that it fits under the merchandise items supported by the rails.

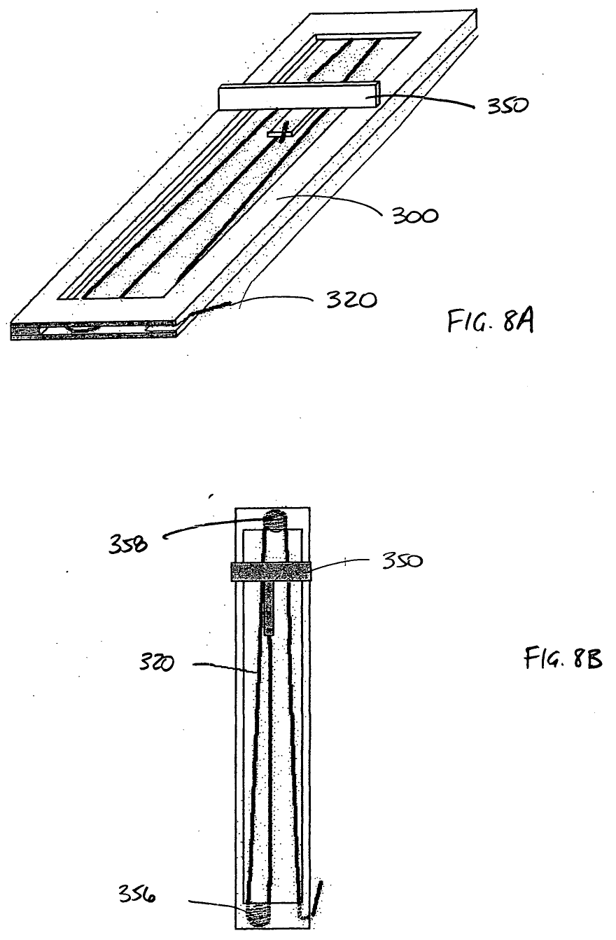

FIG. 8A is a perspective view of an elastic alignment mechanism 300 for use in the system of FIGS. 7A and 7B. In this example, an elastic cord 320 is used as the elastic means, and the cord is routed around pulleys 356 and 358 to drive the rear pull member 350. FIG. 8B is a top view of an elastic alignment mechanism of FIG. 8A. In an alternate embodiment, the pull member may be driven by a spring.

### DETAILED DESCRIPTION OF EMBODIMENT

### Extruded Rear Pull Member

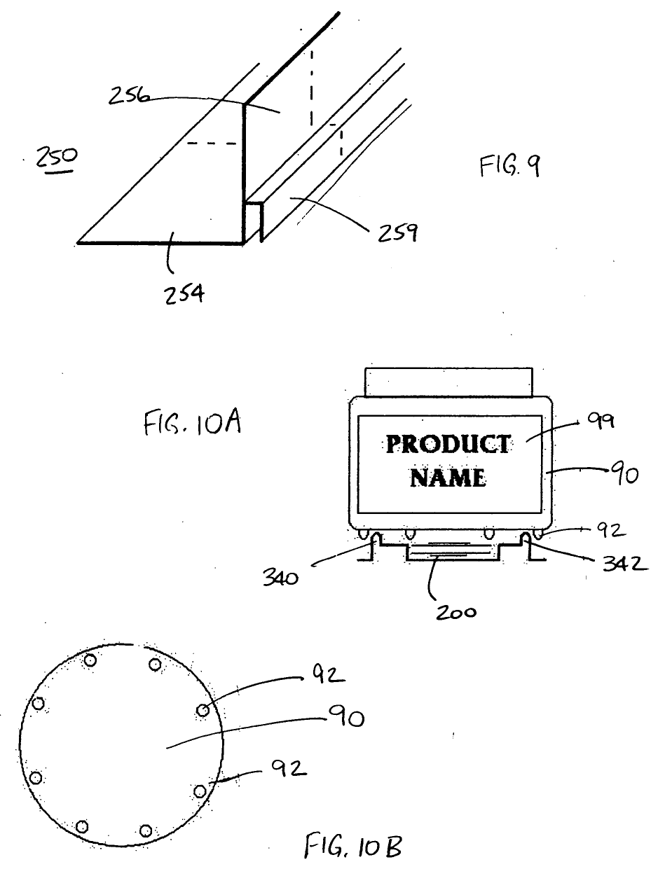

Referring now to FIG. 9, a rear pull member 250 may have a profile that permits the element to be extruded to a relatively long length, and then cut to a desired width. In this embodiment, the rear pull member includes a rear product engagement plate 256 which pushes or pulls the merchandise items forward in the carton along the display base. A lower plate 254 slides along support surfaces 257 and 258 on the display base 220. An optional rear lip 259 which is part of the rear lock 224, may be used to temporarily hold the pull element in an extended position. If the rear lip is used, a lock access hole 226 is typically provided on the display base 220 and in the carton 50 to permit the rear lip to be released from the display base. In FIG. 3A, an optional rear wall 222 is provided on the display base. The rear lip 259 of the rear pull member may be placed over the rear wall 222 in order to hold the rear pull member open. In other embodiments, a display base may be provided without a rear wall.

### DETAILED DESCRIPTION OF EMBODIMENT

### Carton Display with Containers Having Alignment Features

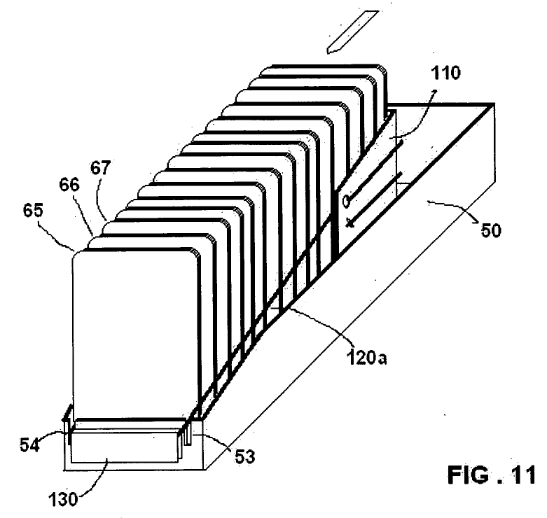

FIG. 10A is a front view of a product container 90 supported on support ridges integral to the carton 50, or on a separate alignment mechanism 200 with support ridges 340 and 342. The elastic alignment mechanism 300 may be used in conjunction with guide features 92 on the bottom of the product container in order to prevent the product label 99 from rotating out of view of a customer. This application is compatible with the alignment system as described in U.S. Pat. No. 6,227,386 to applicant.

FIG. 10B is a bottom view of the container of FIG. 10A. The guide features 92 are preferably located along the outer periphery of the product container in a manner that permits the container to slide on the support ridges 240 and 242 of the base 220 with limited rotation.

The elastic alignment mechanism may be used for a variety of types of merchandise item packages including boxes, jars, cans, or bags. In the case of rounded containers, one or more protrusions or guide features 92 may be provided on the bottom of the container in order to restrict the rotation of the protrusion past a support ridge. A protrusion cannot rotate past a support ridge, so the container orientation is maintained with its front facing in the desired direction as the container is moved along the display base.

### DETAILED DESCRIPTION OF EMBODIMENT

### Carton Display

Many merchandise items are packaged in relatively short display cartons, so that two or more cartons may be placed on the depth of a display shelf. One reason for making the display cartons relatively short is that as merchandise items are removed from the display cartons, other merchandise items in the rear of the carton may become difficult to see, or may tend to fall down.

One embodiment of the current invention is a device and method for pulling the merchandise items to the front of the display carton. By keeping the merchandise items substantially upright and aligned toward the front of the carton, the items are more visible and available to the customer. Another advantage of this type of alignment device is that longer cartons may be used in order to reduce labor costs and to reduce packaging costs.

FIG. 11 is a perspective view of an opened display carton, merchandise items, and an elastic alignment mechanism. A plurality of merchandise items 60-68 are displayed in a partially opened display carton 50. The display carton has a front 52, a first side 56, and a second side 58. The display carton is typically placed on a display shelf such as in a grocery store.

In one embodiment, an elastic alignment device 100 comprises rear pull member 110, a first elastic strip 120a having a first end 123a attached to the rear pull member 110, and a second end 125a; and a second elastic strip 120b having a first end 123b attached to the second side of the rear pull member and a second end 125b.

The elastic alignment device is placed in the opened display carton 50 so that the rear pull member 110 is positioned to the rear of the merchandise items. In some embodiments, the display carton has pre-perforated sections which are removed before display, such as portions of the carton front and sides. The elastic strips 120a and 120b are then stretched on either side of the merchandise items, and the second ends of the elastic strips are secured near to or neat the front of the display carton. In the embodiment of FIG. 11, the ends of the elastic strips are attached to a front retention element 130, a bar, so that the bar is held in place outside of the front 52 of the display carton, and the strips are placed in slots 53 and 54 on the front of the display carton,

In one embodiment, the front retention element 130, holds a product label, or other product identification for the merchandise items in the carton.

As a merchandise item is removed, the first and second elastic strips 120a and 120b pull the rear pull member 110 toward the front of the display carton, thereby aligning the remaining merchandise items toward the front of the display carton. In other embodiments, a single elastic strip may be used. For instance, the ends of a single strip may be secured to the front of the carton, or the ends may be secured to the rear engagement member.

### DETAILED DESCRIPTION OF EMBODIMENT

### Display Base with Elastic Alignment Device and Base

In this embodiment, a elastic alignment device and base 220 is inserted into the bottom of a product display such as a partially opened cardboard box carton; and the display base is used to align merchandise items toward the front of the opened box product display. In one embodiment, the box is cut around its periphery, partially up the sides of the box, so that the bottom portion can be removed. A display base is positioned in the bottom of the box, and the bottom of the box with the display base is placed back over the exposed merchandise items. The merchandise container is then inverted and the top portion is removed so that the merchandise items rest on the display base in the bottom portion of the container. Typically, this partially opened container is placed on a grocery display shelf or on other boxes. As merchandise items are removed from the container, the display base forces the remaining items toward the front of the product display.

### EXAMPLE 5

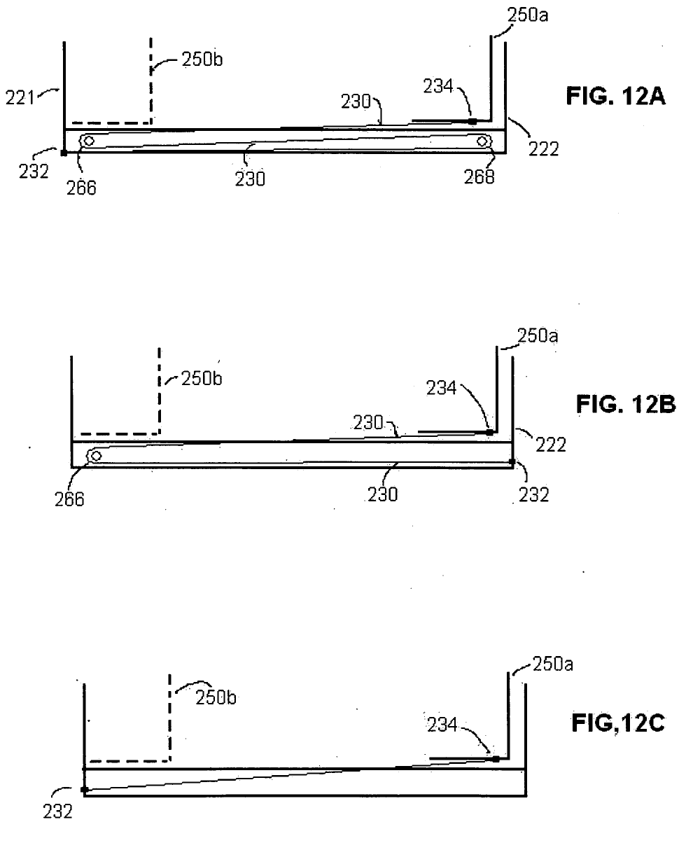

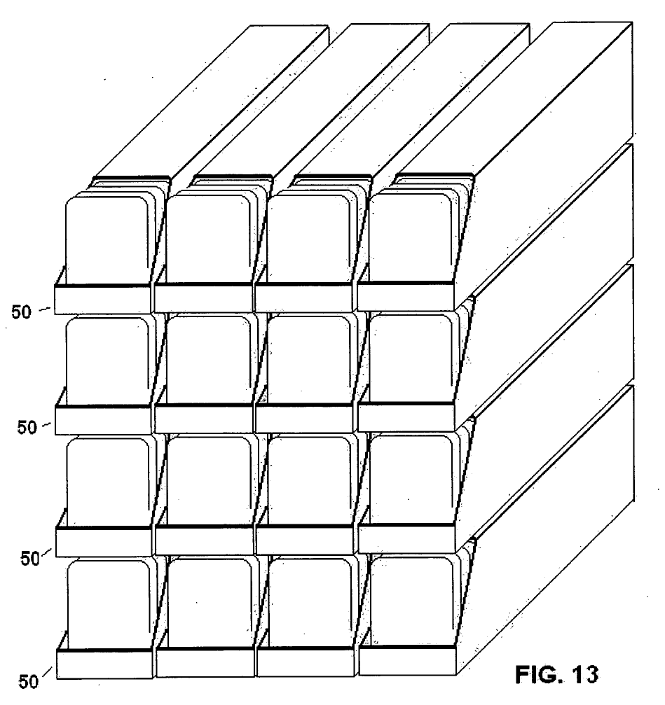

FIG. 12A is a perspective view of an example elastic alignment mechanism with a base. In this example, the alignment drive mechanism has a length of 20 inches, and comprises a strip of elastic material 230, typically a combination of nylon and rubber such as that used in garments, which is attached to the base at its first end 232, and is attached to the rear pull member at its second end 234. In this example, the elastic strip is wrapped over two spaced apart rollers or smooth sheaves or pins 266 and 268. The first sheave s located about 1″ from the front of the device, and the second sheave is located about 1″ from the back of the device. If the elastic strip is attached to the front of the device and to the rear of the base plate of the rear pull member, its total stretched length is 19″+18″+19″=56″. If the base plate is 4 inches long, then the total contracted length is 19″+18″+3″=40″, and the ratio of stretched to unstretched length is about 1.4. Another way of expressing the length of the elastic is relative to the length of the base. In this example, the unstretched length of the elastic is 2.0 times the length of the base, and the stretched length of the elastic is 2.8 times the length of the base

### EXAMPLE 6

FIG. 12B is a perspective view of another example elastic alignment mechanism with a base. In this example, the elastic alignment mechanism of example 5 is used, with a different elastic strip. In this case, the first end of the elastic strip is attached to the rear of the base, and a single sheave 266 is located 1″ from the front of the base. In this example, the total stretched length is 19″+19″=38″. If the base plate is 4 inches long, then the total contracted length is 19″+3″=22″, and the ratio of stretched to unstretched length is about 1.7. In this example, the unstretched length of the elastic is 1.1 times the length of the base, and the stretched length of the elastic is 1.9 times the length of the base.

### EXAMPLE 7

FIG. 12C is a perspective view of another example elastic alignment mechanism with a base. In this example, the elastic alignment mechanism of example 5 is used, with a single elastic strip attached to the front of the base, and no sheave. In this example, the total stretched length is 19″. If the base plate is 4 inches long, then the total contracted length is 4″, and the ratio of stretched to unstretched length is about 4.75. In this example, the unstretched length of the elastic is 0.2 times the length of the base, and the stretched length of the elastic is 0.95 times the length of the base.

As these examples illustrate, the use of one or more sheaves permits the elastic to be used in a manner that substantially decreases the ratio of stretch to unstretched length.

Thus in this example, an elastic material with good expansion and contraction properties is provided, and that elastic material slides smoothly over the sheaves, so that it can be effectively wound partially around one, two, or more sheaves. This combination of smooth travel over a wrap point and multiple wraps permits the elastic to be stretched only a portion of its length. The ability to stretch over only a portion of the length, in turn, provides a consistent force over then length of travel, and it permits the elastic material to be used repeatedly without losing its ability to contract. In this example, the elastic material is wound around the first pin and wound partially around the second pin. The term “wound” in this example is defined as a partial looping around a turn element such as a pin, wheel, or pulley, and a substantial redirection of the elastic material. In this example, the redirection is about 180 degrees. In other examples the redirection angle may be more or less than 180 degrees. The purpose of the sheave is to provide a guide surface for the elastic to stretch and contract, and to provide a means for reversing direction of the elastic strip.

In other embodiments, the attachment point to the base, and the number and position of the sheaves may be varied so that the ratio of working stretch to overall length is varied.

### DETAILED DESCRIPTION OF EMBODIMENT

### Multiple Carton Display Base with Elastic Alignment Devices

FIG. 13 is a front perspective view of a multiple carton display where each carton has an elastic alignment device. In this embodiment, a large display of one or more products may be made by stacking open cartons 50. The elastic alignment mechanisms keep products pulled forward in the display.

### DETAILED DESCRIPTION OF EMBODIMENT

### Multiple Elastic Alignment Devices in a Carton

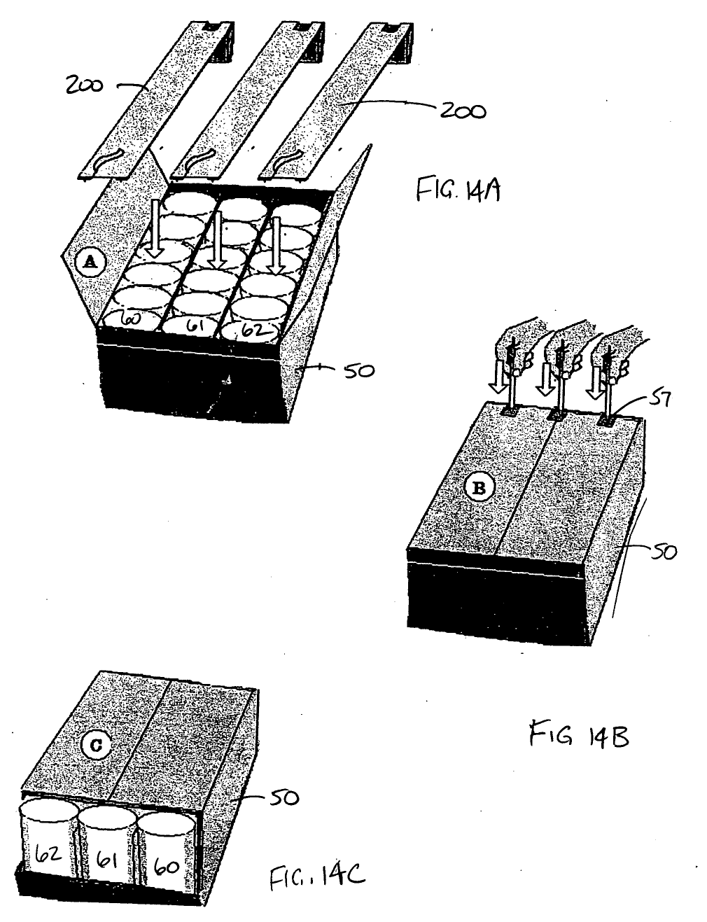

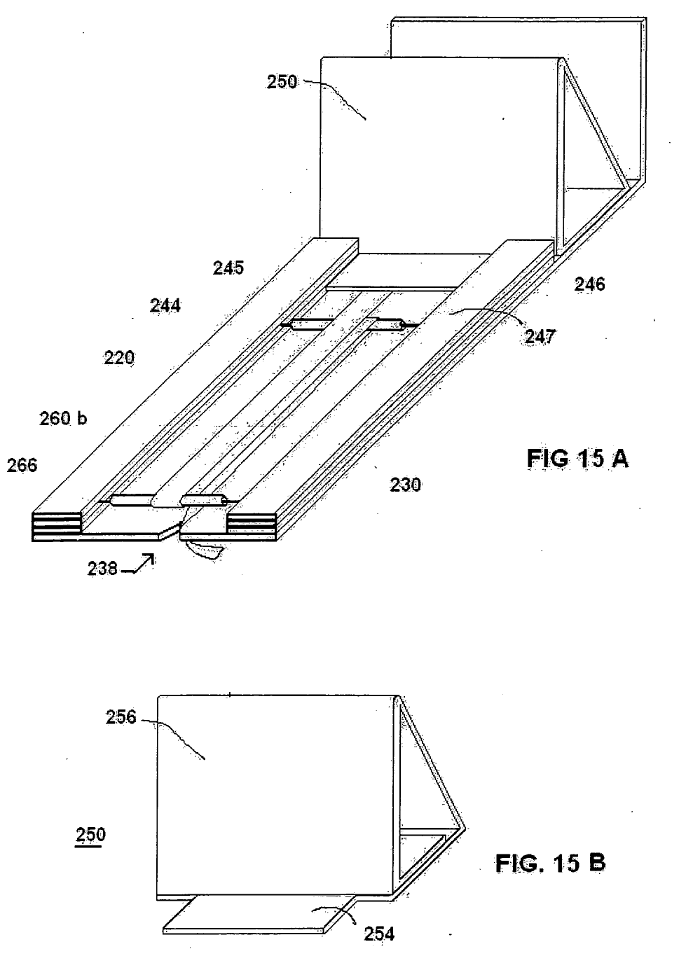

FIG. 14A is a bottom perspective view of a multiple elastic alignment devices placed in a carton. In this example, an elastic alignment device 200 is provided for each row of containers. In other examples, a single elastic alignment device may be used for two or more rows of items. FIG. 14B is a bottom perspective view illustrating unlocking 10 elastic alignment devices of FIG. 14A. FIG. 14C is a top perspective view of a display carton of FIG. 14A where the elastic alignment devices pull the items forward in the open display carton.

### DETAILED DESCRIPTION OF EMBODIMENT

### Thermoformed Elastic Alignment Device

FIG. 15A is a top perspective view of an elastic alignment device. In this example, the base may be thermoformed to provide a low cost device. In this example, two pairs of product support ridges 244 and 245, and 246 and 247 are provided. A thin plastic material may be used, and the ridges and other raised features serve to reinforce the base. In this example, the rear pull member 250 is held in a locked position behind the raised product support ridges. The rear pull member may be unlocked by pushing up on the member from an access hole in the base, so that the elastic pulls the pull member onto the product support ridges.

These embodiments are examples of the invention and it is evident that those skilled in the art can make variations without departing from the inventive concepts, and the invention should be limited solely by the spirit and scope of the claims.

1. An elastic alignment mechanism for pulling forward items in a display carton, the carton having a length and a front, the elastic alignment mechanism comprising
a rear pull member;
at least one elastic strip having a first portion and a second portion, such that the first portion engages the rear pull member; and
a strip anchoring means for securing the second portion of the strip to athe carton, such that the elastic strip is stretched, thereby applying a force to the rear pull member, such that the rear pull member engages the rearmost item in the carton and forces the item toward the front of the display carton.

2. The elastic alignment mechanism of claim 1 wherein the rear pull member further comprises
a first side extension; and
a second side extension.

3. The elastic alignment mechanism of claim 1 comprising
a first elastic strip having a first end secured to the rear pull member, and a second end secured to the strip anchoring means; and
a second elastic strip having a first end secured to the rear pull member, and a second end secured to the strip anchoring means.

4. The elastic alignment mechanism of claim 3 further comprising
a first slot in the front of the carton, such that a portion of the first elastic strip, in proximity to the first end of the first elastic strip, is positioned in the first slot; and
a second slot in the front of the carton, such that a portion of the second elastic strip, in proximity to the first end of the second elastic strip, is positioned in the first slot.

5. The elastic alignment mechanism of claim 1 comprising
a single elastic strip having a first end secured to the strip anchoring means, a second end secured to the strip anchoring means, and a portion between the first end and the second end which engages the rear pull member.

6. The elastic alignment mechanism of claim 5 wherein
the portion between the first end and the second end is attached to the rear pull member.

7. The elastic alignment mechanism of claim 1 wherein
the elastic strip comprises
a first strip of an elastic material, and
a second strip of an elastic material.

8. The elastic alignment mechanism of claim 7 wherein
the first strip has a stretched to unstretched ratio of about 2 to 4.

9. The elastic alignment mechanism of claim 1 wherein
the elastic strip is a band of an elastic material.

10. An elastic alignment mechanism for pulling forward items in a display carton, the carton having a length and a front, the elastic alignment mechanism comprising
a rear pull member;
a first elastic strip comprising
a first end affixed to the rear pull member, and
a second end comprising a first strip anchoring means, such that the first elastic strip may be stretched between the first elastic strip anchoring means and the rear pull member; and
a second elastic strip comprising
a first end affixed to the rear pull member, and
a second end comprising a second strip anchoring means, such that the second elastic strip may be stretched between the second elastic strip anchoring means and the rear pull member.

11. A system for pulling forward items in a display carton, the system comprising
a carton having a length and a front;
a plurality of product items in the carton; and
an elastic alignment mechanism comprising
a rear pull member;
at least one elastic strip having a first portion and a second portion, such that the first portion engages the rear pull member; and
a strip anchoring means for securing the second portion of the strip to the carton, such that the elastic strip is stretched, thereby applying a force to the rear pull member, such that the rear pull member engages the rearmost item in the carton and forces the item toward the front of the display carton.

12. The system of claim 11 wherein
the elastic alignment mechanism is packaged in the carton.

13. A method of aligning merchandise items in a display carton, the method comprising
providing a plurality of merchandise items in a partially opened display carton, the carton having a front, a first side, a second side, and a length;
providing an elastic alignment mechanism comprising
a rear pull member comprising
a rear plate, having a width of about the width of the merchandise items,
a first side extension, and
a second side extension,
a first elastic strip having a first end attached to the rear pull member and a second end, and
a second elastic strip having a first end attached to the rear rear pull member and a second end;
placing the elastic alignment device in the partially opened display carton so that the rear pull member is positioned to the rear of the merchandise items;
positioning and stretching the first elastic strip between the merchandise items and the first side of the carton;
securing the second end of the first elastic strip in proximity to the front of the display carton;
positioning and stretching the second elastic strip between the merchandise items and the second side of the carton; and
securing the second end of the second elastic strip in proximity to the front of the display carton, such that as a merchandise item is removed, the first and second elastic strip pull the rear engagement member toward the front of the display carton, thereby aligning the remaining merchandise items toward the front of the display carton.

14. The method of claim 13 further comprising
providing a front retention element having a first end and a second end;
securing the second end of the first elastic strip to the first end of the front retention element;
securing the second end of the second elastic strip to the second end of the front retention element;
providing a first slot in the front of the display carton;
providing a second slot in the front of the display carton;
placing a portion of the first elastic strip in the first slot and placing a portion of the second elastic strip in the second slot such that the front retention element is held in place on the opposite surface of the front of the product carton from the merchandise items, thereby permitting the first elastic strip and the second elastic strip to be stretched.

15. The method of claim 14 further comprising
providing the elastic alignment mechanism in the carton at the time that a carton is packaged.

16. A product display base for use in displaying and aligning merchandise items in a merchandise carton, the display base section comprising:
a housing with a front and a rear, the housing comprising
a bottom surface,
a first support means, and
a second support means, such that the second support means is spaced apart from the first support means, and such that the first support means and the second support means may hold a plurality of merchandise items in a position that is elevated with respect to the bottom surface of the housing; and
an elastic alignment mechanism comprising
a rear pull member having a merchandise engagement plate, such that the merchandise engagement plate may engage a merchandise item,
at least one elastic strip positioned above the bottom surface and below the merchandise items, the elastic strip having a first end and a second end, such that a portion of the elastic material is affixed to the rear pull member in proximity to a first end of the elastic material, and such that second end of the elastic strip is secured to the housing, such that the elastic strip pulls the rear pull member toward the front of the housing.

17. The product display base of claim 16 further comprising
a first sheave supported by the housing in proximity to the front of the housing, such that the second end of the elastic strip is secured to the base in proximity to the rear of the base, and such that the elastic strip is wound partially around the first sheave.

18. The product display base of claim 16 further comprising
a first sheave supported by the housing in proximity to the front of the housing;
and a second sheave supported by the housing in proximity to the rear of the housing,
such that the second end of the elastic strip is secured to the base in proximity to the front of the base, and such that the elastic strip is wound partially around the second sheave and is wound partially around the first sheave.

19. The product display base of claim 16 further comprising
a locking means which keeps elastic alignment mechanism in an extended position until time to place the carton in service.

20. A product display base for use in displaying and aligning merchandise items in a merchandise carton, the display base section comprising:
a housing with a front and a rear, the housing comprising
a bottom surface,
a first support means, and
a second support means, such that the second support means is spaced apart from the first support means, and such that the first support means and the second support means may hold a plurality of merchandise items in a position that is elevated with respect to the bottom surface of the housing; and
an spring alignment mechanism comprising
a rear pull member having a merchandise engagement plate, such that the merchandise engagement plate may engage a merchandise item,
a spring positioned above the bottom surface and below the merchandise items, the spring having a first end and a second end, such that a portion of the spring is affixed to the rear pull member in proximity to a first end of the spring, and such that second end of the spring is secured to the housing, such that the spring pulls the rear pull member toward the front of the housing.

21. A system for pulling forward items in a display carton, the system comprising
a carton having a length and a front;
a plurality of product items in the carton; and
a product display base comprising
a housing with a front and a rear, the housing comprising
a bottom surface,
a first support means, and
a second support means, such that the second support means is spaced apart from the first support means, and such that the first support means and the second support means may hold a plurality of merchandise items in a position that is elevated with respect to the bottom surface of the housing; and
an elastic alignment mechanism comprising
a rear pull member having a merchandise engagement plate, such that the merchandise engagement plate may engage a merchandise item,
at least one elastic strip positioned above the bottom surface and below the merchandise items, the elastic strip having a first end and a second end, such that a portion of the elastic material is affixed to the rear pull member in proximity to a first end of the elastic material, and such that second end of the elastic strip is secured to the housing, such that the elastic strip pulls the rear pull member toward the front of the housing.

22. A method for displaying and aligning merchandise items in a merchandise carton, the method comprising,
placing a display base between the bottom portion of the merchandise carton and a plurality of merchandise items, the display base comprising
an elastic means for forcing the merchandise items to the front portion of the display base;
displaying the merchandise items;
removing a merchandise item; and
automatically aligning the remaining items toward the front of the display base.

23. A method of aligning merchandise items in a display carton, the method comprising
providing a plurality of merchandise items in a display carton, the carton having a bottom, a front, a first side, and a second side, such that the merchandise items and the carton are inverted and the bottom is open;
providing an alignment device comprising
a display base,
a rear pull member which may travel on the display base, and
an elastic alignment mechanism to force the rear pull member to the front of the display base
placing the elastic alignment mechanism over the inverted merchandise items in the inverted display carton;
closing the display carton;
inverting the display carton; and
preparing the display carton at a point of sale by removing at least part of the display carton in order to expose one or more merchandise items.

24. The method of claim 23 further comprising
locking the rear pull member to the base; and
unlocking the rear pull member from the base.

26. A system for pulling forward items in a display carton, the system comprising
a carton having a length and a front, the carton comprising
a first product support rail, and
a second product support rail, such that the second rail is spaced apart from the first rail;
a plurality of product items in the carton; and
an elastic alignment mechanism comprising
a rear pull member;
at least one elastic strip having a first portion and a second portion, such that the first portion engages the rear pull member; and
a strip anchoring means for securing the second portion of the strip to the carton, such that the elastic strip is stretched, thereby applying a force to the rear pull member, such that the rear pull member engages the rearmost item in the carton and forces the item toward the front of the display carton,
such that the elastic alignment mechanism may be inserted between the first product support rail and the second product support rail.
